(19) United States
(12) Patent Application Publication
(10) Pub. No.: US 2003/0017316 A1
(43) Pub. Date: Jan. 23, 2003

(54) Optical multilayered systems

(75) Inventors: Gerhard Pfaff, Munster (DE); Stephanie Andes, Hanau (DE); Ute Honeit, Darmstadt (DE); Gerald Fuchs-Pohl, Weiterstadt (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/166,714

(22) Filed: Jun. 12, 2002

(30) Foreign Application Priority Data
Jun. 12, 2001 (DE) 101 28 488.8

(51) Int. Cl. B32B 9/00; B32B 5/16; B32B 15/02

(52) U.S. Cl. 428/212; 428/403; 428/701; 428/472; 428/697; 428/336

(57) ABSTRACT

An optical multilayered system comprises metal layers and a plurality of layers, where these layers comprise at least one layer pack (A) comprising a colorless dielectric layer of a material having a refractive index n of ≦1.8 and a colorless dielectric layer of a material having a refractive index n of >1.8, and a selectively or non-selectively absorbent layer (B).

The invention relates to optical multilayered systems based on metal layers and dielectric layers, to a process for their production, and to their use.

Optical multilayered systems having layers of reflective materials, in particular metals, are known and are widely used in many areas of industry, for example for securities, for the production of automotive paints and decorative coating materials and for the pigmentation of plastics, paints, printing inks, paper, in particular for security printing, and the like.

JP H7-759(A) discloses a multilayered interference pigment having metallic lustre which consists of a substrate of aluminium, gold or silver platelets or platelets of mica or glass which are coated with metals, and alternating layers of titanium dioxide and silicon dioxide located thereon. This pigment has high hiding power. However, the metallic core reflects the incident light to a very great extent, and consequently the interference effect caused by the metal oxide layers is only evident to a very small extent and the hard metallic lustre dominates the appearance of the pigments.

U.S. Pat. No. 4,434,010 describes optical multilayered systems and pigments having a central layer of an opaque, reflective material, for example aluminium, gold, copper or silver, which are coated on both sides with a first layer of a low-refractive-index, dielectric material, such as silicon dioxide, magnesium fluoride or aluminium oxide, and a second, semi-opaque metal layer of chromium, nickel or Inconel.

These layered systems and pigments are employed primarily for securities and the printing of securities and exhibit colours which vary with the viewing angle.

Optical multilayered systems and pigments produced therefrom which comprise a multilayered interference film and have a colour shift are described in U.S. Pat. No. 6,157,489. They have a central reflection layer of aluminium, silver, copper or the like to which layers of high-refractive-index dielectric materials, such as, for example, titanium dioxide, zinc sulfide or yttrium oxide are applied on both sides, and an absorption layer of chromium, nickel, palladium, titanium, etc., is applied thereto.

DE 44 37 753 discloses multicoated metallic lustre pigments which have, on metallic substrates, a layer pack comprising

(A) a colourless coating having a refractive index n of ≦1.8 and

(B) a selectively absorbent coating having a refractive index n of ≧2.0 and, if desired, additionally

(C) an outer, colourless or selectively absorbent coating which is different from the underlying layer (B).

Layer (A) here consists, for example, of silicon dioxide, aluminium oxide or magnesium fluoride, while layer (B) is composed of selectively absorbent, high-refractive-index oxides or of “tinted” colourless high-refractive-index oxides. These pigments are said to have interesting coloristic properties and be suitable for producing a colour flop, i.e. a varying coloured appearance depending on the viewing angle.

A common feature of the optical multilayered systems and pigments disclosed in the three last-mentioned publications is that the interference colour of the pigments is determined essentially by the refractive index and thickness of the first layer on the metallic substrate, which has either a low or high refractive index, and by the colour absorption of the layer located thereon. The angle dependence and the colour intensity of the interference colour are, by contrast, controlled only by the composition and thickness of the first layer. Influencing means which enable fine adjustment of the colour intensity of the interference colour and/or the width of the range in which an angle-dependent colour flop takes place are therefore missing.

An object of the invention was is therefore to provide optical multilayered systems based on metal layers and dielectric layers which have high hiding power, high colour intensity and/or strong angle dependence of the interference colour over a broad range, and whose desired colour properties can be adjusted in a simple manner, and to provide a process for their production and to indicate suitable potential uses.

Upon further study of the specification and appended claims, further objects and advantages of this invention will become apparent to those skilled in the art.

These objects are achieved in accordance with the invention by optical multilayered systems comprising a metal layer and a plurality of layers applied to both sides or one side thereof, comprising,

(A) at least one layer pack consisting of

i) a colourless dielectric layer of a material having a refractive index n of ≦1.8 and

ii) a colourless dielectric layer of a material having a refractive index n of >1.8, and

(B) a selectively or non-selectively absorbent layer,

where neither of layers (A) and (B) completely surrounds the metal layer.

The multilayered systems according to the invention may optionally have an outer layer (C).

The invention likewise relates to a process for the production of the above-defined optical layered systems in which metal layers, dielectric layers and absorbent layers are deposited on a belt in such a way that the metal layer is coated on one side or both sides with layers (A), (B) and optionally (C).

The invention additionally also relates to the use of the above-defined multilayered systems in paints, coatings, printing inks, plastics, cosmetic formulations, ceramic materials, paper, films, packaging materials, glasses, pigment preparations, dry preparations, in security applications and for laser marking.

The term optical multilayered systems is taken to mean multilayered optical films and pigments, the latter being produced from the films by comminution.

The metal layer is opaque to light or partially transparent to light and reflective and may comprise all metals and alloys known for metal effects, for example iron, steel, in particular stainless steel, aluminium, copper, nickel, chromium, zinc, tin, silver, gold, platinum, cobalt, lanthanides and titanium, and mixtures or alloys of two or more metals, such as brass or bronzes.

The metal layer preferably consists of aluminium.

If the metal layer is partially transparent, it has a thickness of 5-35 nm. If it is opaque to light, it has a thickness of greater than 35 nm.

The layer pack (A) consists of a colourless dielectric layer i) of a material having a refractive index n of ≦1.8 and a colourless dielectric layer ii) of a material having a refractive index n of >1.8. The sequence of these layers is not stipulated and can be determined depending on the desired colour effects. Surprisingly, it has been found that the sequence of layer application has a significant effect on the colour properties of the optical multilayered system according to the invention although the systems known from the prior art which have either a layer i) or a layer ii) with an otherwise identical layer structure have optical properties which are essentially comparable with one another.

If firstly a layer i) having a refractive index of n≦1.8 and then a layer ii) having a refractive index of n>1.8 are applied to the metal layer, an increase in the intensity of the interference colour and/or a broadening of the colour range in which a colour flop can be observed, depending on the viewing angle, is evident compared with the application of individual layers, irrespective of their refractive index, with an otherwise identical layer structure.

If, by contrast, firstly a layer ii) having a refractive index of n>1.8 and then a layer i) having a refractive index of n≦1.8 are applied to the metal layer, it is possible to set a colour flop, depending on the viewing angle, which does not, as is usual in the case of known systems having only one dielectric layer and an otherwise identical layer structure which are known from the prior art, exhibit a colour shift from one interference colour via all conceivable intermediate shades to the next interference colour, but instead in which two different interference colours alternate with one another via a non-colour on a change in the viewing angle, in addition to an increase in the intensity of the interference colour with an otherwise identical layer structure. Thus, for example, it is possible to set a hard colour change from purple via a non-colour to green.

The arrangement of the sequence of layers i) and ii) and the selection of the materials for these layers and the determination of the individual thicknesses of the layers therefore give rise to a multiplicity of ways for the person skilled in the art to be able to produce optically attractive multilayered systems for a very wide variety of areas of application in a targeted manner. The individual measures necessary for this purpose are generally known to the person skilled in the art and do not require an inventive step.

The layer pack (A) is present one or more times in the optical multilayered systems according to the invention, but preferably once.

The colourless dielectric layer i) of a material having a refractive index n of ≦1.8 is composed of suitable metal compounds, such as metal oxides or metal fluorides, or mixtures thereof which can be applied in a film-like and durable manner.

Examples thereof are SiO₂, Al₂O₃, B₂O₃ and MgF₂.

Preference is given to SiO₂, and MgF₂ or mixtures thereof, and particular preference is given to SiO₂.

The thickness of this layer is generally from 100 to 1000 nm, preferably from greater than 150 to 600 nm.

For the colourless dielectric layer ii) of a material having a refractive index n of >1.8, use is made of metal compounds, preferably metal oxides or metal sulfides, or mixtures thereof, for example TiO₂, ZrO₂, SiO, HfO₂, Y₂O₃, Ta₂O₅, ZnO, SnO₂ or ZnS, but preferably TiO₂ and ZnS and in particular TiO₂.

This layer has a thickness of from 30 to 500 nm and in particular from 200 to 350 nm.

The selectively or non-selectively absorbent layer (B) is not restricted with respect to the refractive index of the applied material or material mixture and can comprise both high-refractive-index and low-refractive-index materials. However, it is at least partially transparent to light (semi-transparent) and must therefore be carefully matched to the various materials employed with respect to its layer thickness.

Suitable materials are, in particular, metals, such as, for example, chromium, tungsten, cobalt, nickel, copper, molybdenum, iron, silver, gold, palladium, titanium, vanadium, niobium, platinum, but also aluminium and mixtures or alloys of two or more metals. An example thereof is Inconel, an alloy comprising 76% by weight of nickel, 15% by weight of chromium and 9% by weight of iron.

Likewise suitable, however, are also metal oxides, in particular those which are absorbent per se, but also those which can be rendered absorbent by incorporation of or coating with absorbent materials.

Particularly suitable metal oxides here are the various iron oxides of various modifications, chromium(III) oxide, titanium(III) oxide and the known coloured titanium suboxides, vanadium dioxide, vanadium trioxide or alternatively mixed oxides as well as mixtures.

Furthermore, layer (B) can be formed by non-selectively absorbent materials. Examples thereof are magnesium fluoride or silicon monoxide which comprise chromium or titanium monoxide which likewise comprises chromium.

The layer thickness of layer (B) is determined by the material employed and the requirement that this layer must be at least partially transparent to visible light.

For non-selectively absorbent materials, the thickness of this layer is from about 5 to 100 nm, with the lower range from 5 to 25 nm, in particular from 5 to 20 nm, being sufficient for strongly absorbent metals, such as chromium and molybdenum.

If, by contrast, selectively absorbent metal oxides are employed, the thickness of layer (B) can be from 5 to 500 nm, preferably from 10 to 100 nm.

In the present invention, layer (B) preferably consists of chromium having a layer thickness of from 5 to 20 nm, of Fe₂O₃ having a layer thickness of from 10 to 100 nm, or of aluminium having a layer thickness of from 5 to 30 nm.

The selectively or non-selectively absorbent layer (B) attenuates the reflection of the incident visible light at the metal layer and amplifies the colour effect set by interlayers I) and ii). In particular in the case of incorporation of the pigments obtained from the optical multilayered system into the conventional coloured coating systems, the optical advantages of these pigments, such as increased intensity of the interference colours together with high hiding power and metallic lustre, as well as specifically set, expanded colour ranges for the colour flop and an intentionally hard colour change from one colour to another without intermediate hues, are therefore shown to their best advantage.

The optical multilayered systems may optionally also have an outer layer (C). This is preferably intended to protect the underlying layer (B) and to stabilise the pigments in this way.

Materials which can be employed for the outer layer (C) are colourless or selectively absorbent metal oxides, such as, for example, SiO₂, Al₂O₃, TiO₂, ZrO₂, Fe₂O₃ or alternatively Cr₂O₃.

If the multilayered system is in the form of a pigment, it is also possible to carry out a wet-chemical after-treatment, which both increases its chemical stability and improves its handling, in particular to simplify incorporation into various media.

Particularly suitable methods for this purpose are those described in DE 22 15 191, DE 31 51 354, DE 32 35 017, DE 33 34 598, DE 40 30 727, EP 0 649 886, WO 97/29059, WO 99/57204 or U.S. Pat. No. 5,759,255. Layer (C) generally has a thickness of from about 1 to 500 nm.

The optical multilayered systems according to the invention may also contain an additional layer consisting of metal oxides, metal fluorides, metal nitrides or mixtures thereof between the metal layer and the layer pack (A) and/or between the layer pack (A) and layer (B).

The individual layers can be produced by known methods by sputtering of metals, for example, aluminium, chromium or alloys, such as, for example, chromium/nickel alloys, and sputtering of metal oxides, for example, titanium oxide, silicon oxide or indium tin oxide, or by thermal evaporation of metals or metal oxides.

The application of the layers by vapour deposition will be described in greater detail below:

The layered system can be produced on the substrate using a vapour deposition unit consisting of the conventional components, such as a vacuum pump system, pressure measurement and control units, evaporator devices, such as resistance evaporators or electron-beam evaporators, an apparatus for establishing certain pressure conditions and a gas inlet and control system for reactive gases.

The high-vacuum vapour deposition technique is described in detail in Vakuum-Beschichtung [Vacuum Coating], Volumes 1-5; Editor Frey, Kienel and Löbl, VDI-Verlag 1995.

The application of the layers by the sputtering method is carried out as follows:

In the sputtering method or cathode sputtering, a gas discharge (plasma) is ignited between the support and the coating material, which is in the form of plates (target). The coating material is bombarded by high-energy ions from the plasma, for example argon ions, and thereby removed or sputtered. The atoms or molecules of the sputtered coating material are precipitated on the substrate and form the desired thin layer.

Metals or alloys are particularly suitable for sputtering methods. These can be sputtered at comparatively high rates, in particular in the so-called DC magnetron process. Compounds, such as oxides or suboxides, or mixtures of oxides can likewise be sputtered using high-frequency sputtering. The chemical composition of the layers is determined by the composition of the coating material (target). However, it can also be affected by additives to the gas which forms the plasma. In particular, oxide or nitride layers are produced by addition of oxygen or nitrogen in the gas space.

The structure of the layers can be influenced by suitable measures, such as bombardment of the growing layers by ions from the plasma.

The sputtering method is likewise described in Vakuum-Beschichtung [Vacuum Coating], Volumes 1-5; Editor Frey, Kienel and Löbl, VDI-Verlag 1995.

Suitable for the production of the optical multilayered systems according to the invention are preferably continuous or discontinuous PVD vacuum belt coating methods in which the individual layers of the layer system are deposited one after the other. In this way, symmetrical or asymmetrical multilayered systems can be produced in accordance with the present invention. For the production of the multilayered system, a suitable belt-shaped support must be present. This support is a flexible material which is transparent or opaque, preferably transparent, for example, a polyester, such as polyethylene terephthalate. Depending on the desired further use of the multilayered system according to the invention, this support is preferably coated with a release layer which is soluble in a solvent or on heating if the multilayered system is to be used further detached from the support and optionally in pigment form. However, the support may, even without further pre-coating, be coated immediately with the multilayered system according to the invention if a use is intended in which the multilayered system according to the invention is to be used in the form of defined areas, for example strip-shaped, circular or similar areas. It is likewise possible to provide the support both with a release layer and with an adhesive layer before the multilayered system according to the invention is deposited. In this case, the multilayered system can be detached from the support as a film and subsequently applied in film form to other materials by means of the adhesive layer.

It goes without saying that in order to produce a symmetrical multilayered system of the type in accordance with the invention on a belt-shaped support, firstly the outer layer of the system, e.g., optionally layer (C), is deposited on the belt as the first layer. In the case of an asymmetrical multilayered system, the metal layer may also be deposited on the belt as the first layer. Further, in the case of an asymmetrical system, any of the layers can be deposited first, provided that the sequence of the outer layers remains unchanged, for example: first layer (B), then layer pack (A), then the metal layer, then another layer pack (A) in an inverted manner with respect to the first layer pack (A), then layer (B), and then layer (C); or first a layer pack (A), then the metal layer, the another layer pack (A) in an inverted manner with respect to the first layer pack (A), then layer (B), and then optionally layer (C); or first the metal layer, then layer pack (A) in any manner, then layer (B), then optionally layer (C).

If the multilayered systems according to the invention are in the form of pigments, they are compatible with a multiplicity of colour systems, preferably from the area of paints, coatings and printing inks. These pigments are furthermore also suitable in plastics, ceramic materials, paper, glasses, for the laser marking of paper and plastics, in security applications, films and packaging materials, and for applications in the agricultural sector, for example for greenhouse sheeting. Owing to their high tinting strength, they can also, in particular, advantageously be employed in cosmetic formulations, for example in decorative cosmetics. They are likewise suitable for the production of pigment preparations and dry preparations, such as, for example, granules, chips, pellets, briquettes, etc., which are used, in particular, in printing inks and paints.

Dry preparations are granules, chips, pellets, briquettes, etc., which are composed of one or more of the inventive multilayered systems in pigment form, one or more binders, and one or more additives. They are made from pastes, containing these ingredients and a solvent or diluent, by drying the paste and then bringing them into the desired shape.

For the various applications, the multilayered systems in pigment form can also advantageously be employed in mixtures with commercially available dyes and pigments, for example organic dyes, organic pigments or other pigments, such as, for example, transparent and opaque white, coloured and black pigments, and with platelet-shaped iron oxides, organic pigments, holographic pigments, LCPs (liquid crystal polymers), and conventional transparent, coloured and black lustre pigments based on metal oxide-coated mica and SiO₂ platelets, etc. The multilayered pigments can be mixed with commercially available pigments, binders and fillers in any ratio.

If the multilayered systems according to the invention are employed in flat form, they are particularly suitable for the production of, or directly as, films and packaging materials. These are taken to mean, in particular, cold-embossing films, hot-embossing films, lamination films, decorative films, coating films, shrink films or parts thereof.

Particular importance is also attached to use in security applications, for example as security threads or strips for banknotes, securities, identity cards, identity card sleeves or the like.

The optical multilayered systems according to the invention have high hiding power and exhibit intense interference colours. Depending on the sequence of the applied layers, colour effects, such as, for example, a broadening of the colour range in which colour changes can be observed depending on the illumination or viewing angle, or, however, a hard colour transition from one colour to another without the usual intermediate hues can be set specifically.

The complete disclosure content of all patent applications, patents and publications mentioned above, including the corresponding German patent application DE 101 28 488.8, is incorporated into this application by way of reference.

The following examples are intended to explain the invention in greater detail, but without restricting it.

In the foregoing and in the following examples, all temperatures are set forth uncorrected in degrees Celsius; and, unless otherwise indicated, all parts and percentages are by weight.

### EXAMPLES

### Example 1

An optical multilayered system having the layer structure described below is produced by vapour deposition onto a film of polyethylene terephthalate. The film is coated with a release layer of stearin. The vapour deposition is carried out in a Leybold AG A700Q high-vacuum vapour deposition unit.

Layer Structure of the Pigment

| Layer No. | Material | Layer thickness (nm) |
|---|---|---|
| 1 | Cr | 5 |
| 2 | TiO₂ | 20 |
| 3 | SiO₂ | 200 |
| 4 | Al | 100 |
| 5 | SiO₂ | 200 |
| 6 | TiO₂ | 20 |
| 7 | Cr | 5 |

The layer system is detached from the film using acetone, washed with acetone, dried and ground in a Netsch mortar mill for 30 minutes, giving a pigment having an average particle size of 40 μm.

The pigment exhibits an intensely coloured gold hue with a pronounced colour flop to blue-green.

### Example 2

An optical multilayered system having the layer structure described below is produced by vapour deposition onto a film of polyethylene terephthalate.

The film is coated with a release layer of stearin. The vapour deposition is carried out in a Leybold AG A700Q high-vacuum vapour deposition unit.

Layer Structure of the Pigment

| Layer No. | Material | Layer thickness (nm) |
|---|---|---|
| 1 | Cr | 5 |
| 2 | SiO₂ | 380 |
| 3 | TiO₂ | 130 |
| 4 | Al | 100 |
| 5 | TiO₂ | 130 |
| 6 | SiO₂ | 380 |
| 7 | Cr | 5 |

The layer system is detached from the film using acetone, washed with acetone, dried and ground in a Netsch mortar mill for 30 minutes, giving a pigment having an average particle size of 40 μm.

The pigment exhibits a pronounced colour change from an intense purple via a non-colour to an intense green.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. An optical multilayered system comprising a metal layer and a plurality of layers applied thereto on both sides of said metal layer or on one side of said metal layer, said plurality of layers comprising
A) at least one layer pack consisting of
iii) a colourless dielectric layer of a material having a refractive index n of ≦1.8, and
iv) a colourless dielectric layer of a material having a refractive index n of >1.8; and
C) a selectively or non-selectively absorbent layer,
where neither of layers (A) and (B) completely surrounds the metal layer.

2. A multilayered system according to claim 1, in the form of platelet-shaped particles.

3. A multilayered system according to claim 1, in the form of a film.

4. A multilayered system according to claim 1, further comprising an outer layer (C).

5. A multilayered system according to claim 1, wherein the metal layer comprises a metal, metal alloy or mixtures thereof.

6. A multilayered system according to claim 1, wherein the material having a refractive index n of ≦1.8 for layer i) is selected from metal oxides, metal fluorides or mixtures thereof.

7. A multilayered system according to claim 1, wherein the material having a refractive index n of >1.8 for layer ii) is selected from metal oxides, metal sulfides and mixtures thereof.

8. A multilayered system according to claim 6, wherein the material having a refractive index n of >1.8 for layer ii) is selected metal oxides, metal sulfides and mixtures thereof.

9. A multilayered system according to claim 1, wherein the selectively or non-selectively absorbent layer is made of an at least partially light-transparent metal, a selectively absorbent metal oxide, or alloys or mixtures thereof.

10. A multilayered system according to claim 5, in which the metal layer is made of iron, steel, stainless steel, aluminium, copper, nickel, chromium, zinc, tin, silver, gold, platinum, cobalt, a lanthanide, titanium, or mixtures or alloys thereof.

11. A multilayered system according to claim 6, in which the material having a refractive index n of ≦1.8 for layer i) is SiO₂, Al₂O₃, B₂O₃, MgF₂, or a mixture thereof.

12. A multilayered system according to claim 11, in which the material having a refractive index n of ≦1.8 for layer i) is SiO₂, MgF₂ or a mixture thereof.

13. A multilayered system according to claim 12, in which the material having a refractive index n of ≦1.8 for layer i) is SiO₂.

14. A multilayered system according to claim 7, in which the material having a refractive index n of >1.8 for layer ii) is TiO₂, ZrO₂, SiO, HfO₂, Y₂O₃, Ta₂O₅, ZnO, SnO₂, ZnS or mixtures thereof.

15. A multilayered system according to claim 8, in which the material having a refractive index n of >1.8 for layer ii) is TiO₂, ZrO₂, SiO, HfO₂, Y₂O₃, Ta₂O₅, ZnO, SnO₂, ZnS or a mixture thereof.

16. A multilayered system according to claim 14, in which the material having a refractive index n of >1.8 for layer ii) is TiO₂ or ZnS.

17. A multilayered system according to claim 15, in which the material having a refractive index n of >1.8 for layer ii) is TiO₂ or ZnS.

18. A multilayered system according to claim 16, in which the material having a refractive index n of >1.8 for layer ii) is TiO₂.

19. A multilayered system according to claim 17, in which the material having a refractive index n of >1.8 for layer ii) is TiO₂.

20. A multilayered system according to claim 9, in which the selectively or non-selectively absorbent layer (B) comprises chromium, tungsten, cobalt, nickel, copper, molybdenum, aluminium, iron oxide, chromium(III) oxide, titanium(III) oxide, titanium suboxide, vanadium oxide, or mixtures thereof or alloys thereof.

21. A multilayered system according to claim 20, in which the selectively or non-selectively absorbent layer (B) comprises chromium, aluminium, or iron oxide.

22. A multilayered system according to claim 1, in which layer i) has a layer thickness of 100 to 1000 nm.

23. A multilayered system according to claim 22, in which layer i) has a layer thickness of from greater than 150 to 600 nm.

24. A multilayered system according to claim 1, in which layer ii) has a layer thickness of 30 to 500 nm.

25. A multilayered system according to claim 22, in which layer ii) has a layer thickness of 30 to 500 nm.

26. A multilayered system according to claim 24, in which layer ii) has a layer thickness of 200 to 350 nm.

27. A multilayered system according to claim 25, in which layer ii) has a layer thickness of 200 to 350 nm.

28. A multilayered system according to claim 1, in which the layer pack (A) consists of a layer i) on the metal layer and a layer ii) applied thereto.

29 A multilayered system according to claim 1, in which the layer pack (A) consists of a layer ii) on the metal layer and a layer i) applied thereto.

30. A process for the production of the multilayered system according to claim 1, in which said metal layer, the dielectric layers and said absorbent layer are deposited on a flexible support one on top of the other whereby the metal layer is coated with layers (A) or (B) on one side or on both sides thereof.

31. A process for the production of the multilayered system according to claim 4, in which said metal layer, the dielectric layers and said absorbent layer are deposited on a flexible support one on top of the other whereby the metal layer is coated with layers (A) or (B) on one side or on both sides thereof.

32. In a material selected from paints, coatings, printing inks, plastics, cosmetic formulations, ceramic materials, paper, films, packaging materials, glasses, laser markings, security applications, dry preparations or pigment preparations, the improvement wherein said material contains a multilayered system according to claim 1.
